(19) United States
(12) Patent Application Publication
(10) Pub. No.: US 2013/0213902 A1
(43) Pub. Date: Aug. 22, 2013

(54) Method for the removal of contaminants from aqueous solutions using tightly stacked layers of graphene oxide.

(71) Applicants: Dan Browne, Calgary (CA); Alex Yeoh, Calgary (CA)

(72) Inventors: Dan Browne, Calgary (CA); Alex Yeoh, Calgary (CA)

(21) Appl. No.: 13/400,544

(22) Filed: Feb. 20, 2012

(51) Int. Cl. C02F 1/00; B01D 39/00; B01D 29/00

(52) U.S. Cl. 210/767; 210/489; 210/500.1

(57) ABSTRACT

The invention consists of a mechanism the parts of which specified in the invention result in a low energy process for the removal of many and various contaminants from an aqueous solution. The principal parts of the mechanism are to drive the contaminated aqueous solution by means of gravity or low pressure through graphene oxide membrane layers stacked closely at atomic scale.

### DESCRIPTION OF THE DRAWINGS

FIG. 1 shows a high level mockup of the invention, in no implied orientation.

1. Shows the area of the invention which contains the contaminated aqueous solution

2. Shows an arrow indicating the direction of pressure on the contaminated aqueous solution, and the direction of flow of the contaminated aqueous solution as it passes through the substrate.

3. Shows the Layered Graphene Oxide Substrate. Each layer is separated by a small gap such as 0.4-0.6 nanometers. The diagram does not imply a set number of layers in the claim.

4. Shows the area of the invention containing the non-contaminated water after passing through the substrate

5. Shows an arrow indicating the direction of non-contaminated water after passing through the substrate

### TECHNICAL FIELD

The present invention relates to a device which can remove contaminants from an aqueous solution of said contaminants, with low use of energy.

Several current technologies exist for the removal of contaminants such as industrial waste, solvents, bodily fluids, excess salt among others from waste water or aqueous solutions. Most of these technologies, however, rely on external pressure to force the solution through a semi-permeable membrane. This is energy intensive and as such may be prohibitive for some applications particularly those in low income regions and therefore it is strongly desired to decrease the energy component of the process.

### DISCLOSURE OF THE INVENTION

### Problems to be Solved by the Invention

An object of the present invention is to find a device which can enable a low energy process to remove contaminants from an aqueous solution which results in the separation of the contaminants and fresh water thereby significantly reducing the variable energy cost for the process, making fresh water available in a manner which does not incur ongoing energy costs.

### Means for Solving the Problems

In view of the above problems, the inventors of the present invention intensively studied the available arts and concluded that the method most suited to removing contaminants from an aqueous solution with the least energy is the invention.

That is, the present invention discloses: A two chambered device with an active component by means of which, an aqueous solution of water and contaminants is separated into fresh water and contaminants in two separate chambers.

### EFFECT OF THE INVENTION

Use of the present invention enables the extraction of contaminants from the aqueous solution

### BEST MODE FOR CARRYING OUT THE INVENTION

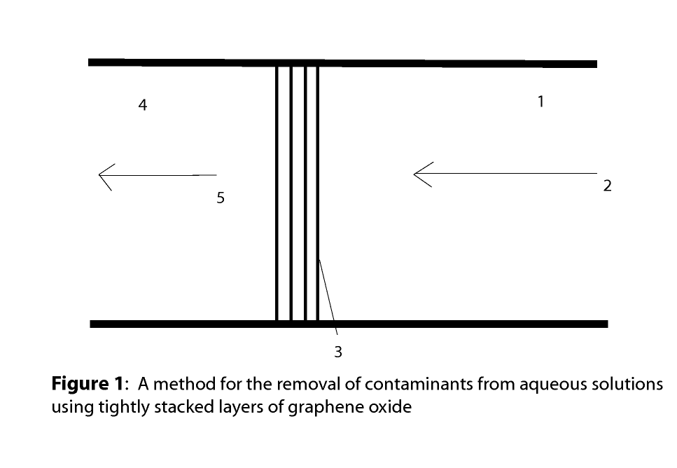

The device for extracting contaminants from an aqueous solution in a low energy manner is shown in FIG. 1.

In the present invention, an aqueous solution is introduced into one chamber of the invention (FIG. 1) and by means of gravity, the water molecules are drawn through the layered grahene oxide substrate while the contaminants are prevented from so doing.

As the active component, a substrate comprised of multiple layers of graphene oxide separated from each other by a small gap such as 0.4-0.6 nanometers.

The active component of the present invention may be subjected to processing treatment for imparting various properties thereto.

The number of layers of the active component in the composition of the present invention varies depending on the form of the invention and can be appropriately determined.

Usually, a person skilled in the art may determine the number of layers of the active component required in the composition of the invention.

Upon preparation of the composition of the present invention, depending on the purpose, raw materials containing useful ingredients for the chambers such as plastics, metals, alloys, or the like in large amounts can be used in combination with the active component of the present invention.

1. A method for the removal of contaminants from aqueous solutions using tightly stacked layers of graphene oxide

2. As the active component of claim 1, a substrate comprised of multiple layers of graphene oxide separated from each other by a small gap such as 0.4-0.6 nanometers

3. A device that uses the substrate described in claim 2 to separate two chambers; where a contaminated aqueous solution in one chamber filters through the substrate leaving the contaminant in the same chamber, and where fresh water exits from the other side of the substrate into the second chamber.
